(19) United States
(12) Patent Application Publication
(10) Pub. No.: US 2003/0082343 A1
(43) Pub. Date: May 1, 2003

(54) Bendable polymeric foam with a reinforced slit

(76) Inventor: Michel J. Brucker, Kilstett (FR)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/242,907

(22) Filed: Sep. 12, 2002

Related U.S. Application Data
(60) Provisional application No. 60/336,277, filed on Nov. 1, 2001.

(51) Int. Cl. B32B 3/00

(52) U.S. Cl. 428/156

(57) ABSTRACT

The present invention is a bendable polymeric foam containing a slit that severs and traverses a primary surface of the foam without severing an opposing primary surface. A densified portion of an opposing primary surface proximate to the slit, including a portion of the opposing primary surface opposite to the slit, reinforces the foam when bending along the slit. The present invention also includes a process for modifying a polymeric foam to form such a bendable foam.

### CROSS REFERENCE STATEMENT

This application claims the benefit of U.S. Provisional Application No. 60/336,277, filed Nov. 1, 2001.

### BACKGROUND OF THE INVENTION

1. Field of the Invention

The present invention relates to a polymeric foam that is bendable along a slit that severs and traverses one primary surface while penetrating into the foam without severing an opposing primary surface. A densified portion of the opposing surface proximate to the slit reinforces the foam.

2. Description of Related Art

Foam structures that are reversibly bendable are desirable. For example, insulating covers for swimming pools and hot tubs often comprise multiple polymeric foam sheets that interconnect in a manner that allows bending to facilitate removal and storage. Polymeric foams that bend reversibly to fit into boxes or to conform to packaged articles can also be beneficial as packaging materials.

Bendable foam structures are not new. For example, U.S. Pat. No. 4,885,820 discloses a means of joining two polymeric foams together using a polymeric film laminated to the two foams. The film acts as a hinge between the foams. U.S. Pat. No. 5,876,813 discloses laminated foam structures comprising a low-density foam core with a higher density foam “skin” laminated to one or more surface of the core. The laminated structures can include a cut through the core to provide a hinge region, allowing bending of the structure at the hinge region.

Patent Cooperation Treaty (PCT) publication WO 01/56773A1 discloses a close-celled polymeric foam plank comprising at least 50 percent polyethylene, by weight of polymer, that is reinforced by a densified skin surface. The foam plank can be die cut or slit to allow for bending. The densified skin spans an entire surface of the foam plank.

However, a bendable foam that does not require laminating multiple materials together and that does not require densifying an entire surface of a foam plank, yet has sufficient reinforcement to be reversibly bendable along a hinge without fracturing is desirable. Such a foam that is open-celled and comprises at least 50 percent polypropylene, by weight of polymer, is even more desirable.

### BRIEF SUMMARY OF THE INVENTION

In a first aspect, the present invention is a polymeric foam comprising a deformable polymer having multiple cells defined therein, wherein said foam has: (a) opposing primary surfaces; (b) at least one slit traversing and severing a primary surface while penetrating a major distance into the foam without severing the opposing primary surface; and (c) a densified portion of the opposing primary surface that is proximate to said slit, including at least a portion of the opposing surface opposite to said slit.

In a second aspect, the present invention is a process for modifying a polymeric foam comprising, in any order, the following steps: (a) introducing a slit that traverses and severs a primary surface of a foam while penetrating into said foam without severing an opposing primary surface; and (b) densifying a portion of said opposing primary surface such that, after introducing the slit, the densified portion of opposing surface is proximate to the slit.

### DETAILED DESCRIPTION OF THE INVENTION

Polymeric foams of the present invention have opposing first and second primary surfaces. Herein, labels of “first” and “second”, in reference to primary surfaces, are for convenience only and are interchangeable. The foams have a thickness corresponding to a shortest distance between a point on one primary surface and an opposing primary surface. Opposing primary surfaces can be parallel, thereby having a uniform thickness. Opposing primary surfaces can also be non-parallel, having a thickness that can vary at different points on a primary surface.

Foams can have any physical configuration including sheet, board, plank, tube, and rod. Primary surfaces of sheet, board, and plank foams lie within a plane defined by the foam's length and width. Primary surfaces of tubular foam structures are inside and outside surfaces of the structure. Rods are unique in that they have a single primary surface. Therefore, “opposing primary surfaces” of a rod refers to different portions of the same primary surface that are at different locations around the rod's circumference, preferably at opposite ends of a cross-sectional diameter.

Prepare polymeric foams of the present invention using a deformable polymer. Deformable polymers can be reversibly softened sufficiently to allow a foam comprising a deformable polymer to at least partially collapse, and thereby increase in density. Thermoplastic polymers are examples of deformable polymers. Soften thermoplastic polymers by applying sufficient heat or chemical softening agent (e.g., solvent or plasticizer) to partially collapse a thermoplastic polymer foam. Suitable thermoplastic polymers include those from a group consisting of alkylenyl aromatic polymers such as polystyrene (PS); rubber-modified alkylene aromatic polymers, such as high impact polystyrene (HIPS); alkylene aromatic copolymers such as styrene/acrylonitrile or styrene/butadiene; hydrogenated alkylene aromatic polymers and copolymers such as hydrogenated polystyrene and hydrogenated styrene/butadiene copolymers; alpha-olefin homopolymers such as polyethylene (PE) (including low density polyethylene (LDPE) and high density polyethylene (HDPE)) and polypropylene (PP); linear low density polyethylene (an ethylene/octene-1 copolymer) and other copolymers of ethylene with a copolymerizable, mono-ethylenically unsaturated monomers such as an alpha-olefin having from 3 to 20 carbon atoms; copolymers of propylene with a copolymerizable, mono-ethylenically unsaturated monomer such as an alpha-olefin having from 4 to 20 carbon atoms; copolymers of ethylene with a vinyl aromatic monomer, such as ethylene/styrene interpolymers (ESI); ethylene/propylene copolymers; copolymers of ethylene with an alkane such as an ethylene/hexane copolymer; thermoplastic polyurethanes (TPU's); and blends or mixtures thereof.

The deformable polymer is preferably PE, PS, PP, a blend of PS and ESI, a blend of ESI and PE, a blend of ESI and PP, a blend of PS, PE and ESI or a blend of ESI with any one or more polyolefin or ethylene/alpha-olefin copolymers, terpolymers or interpolymers. Particularly desirable polymers are PP and blends including PP.

Deformable polymers also include coupled thermoplastic polymers such as coupled PP (see, for example U.S. Pat. No. 5,986,009 column 16, line 15 through column 18, line 44; incorporated herein by reference), coupled blends of alpha-olefin/vinyl aromatic monomer or hindered aliphatic vinyl monomer interpolymers with polyolefins (see, for example, U.S. Pat. No. 6,284,842; incorporated herein by reference) and lightly crosslinked polyolefins, particularly PE (see, for example U.S. Pat. No. 5,589,519; incorporated herein by reference). Excessive crosslinking can render a polymer no longer deformable. A skilled artisan can readily determine an acceptable level of crosslinking to obtain a deformable polymer.

Deformable polymers for use in the present invention desirably contain at least 50 percent (%), more desirably at least 70% PP (coupled or uncoupled), by weight of polymer in the foam. PP is particularly desirably because of it has a higher melt temperature than many other thermoplastic polymers, thereby allowing PP foams to function at higher temperatures (i.e., in higher temperature applications) than foams of other thermoplastic polymers, such as PE. Nonetheless, melt densifying a portion of a PP foam surface is still possible. PP is also sufficiently flexible below its melt temperature to form a tough foam that is not particularly brittle.

Generally, prepare a polymeric foam by plasticizing a deformable polymer, incorporating therein a blowing agent composition at an initial pressure to form a foamable composition, and then exposing the foamable composition to a foaming pressure that is lower than the initial pressure and allowing the foamable composition to expand into foam. Plasticizing the deformable polymer typically involves heating it to a processing temperature at or above the polymer's glass transition temperature, or melt temperature for crystalline polymers. Cooling a heat plasticized foamable composition below the processing temperature prior to exposing the foamable composition to the foaming pressure can optimize foam properties. Cool the foamable composition, for example, in an extruder or other mixing device or in separate heat exchangers.

A skilled artisan recognizes there are many variations of the general procedure as well as other ways to prepare polymeric foam that are suitable for use in the present invention. For example, U.S. Pat. No. 4,323,528, herein incorporated by reference, discloses a process for making polymeric foam via an accumulating extrusion process.

Coalesced polymeric foams are particularly desirable for use in the present invention. Coalesced polymeric foams comprise a plurality of distinguishable, coalesced, extruded longitudinal foam members. Longitudinal foam members typically extend the length (extrusion direction) of a coalesced polymeric foam. Longitudinal foam members are strands, sheets, or a combination of strands and sheets. Sheets extend the full width or height of a coalesced polymeric foam while strands extend less than the full width and height. Width and height are orthogonal dimensions mutually perpendicular to the extrusion direction (length) of a foam. Strands can be of any cross-sectional shape including circular, oval, square, rectangular, hexagonal, or star-shaped. Strands in a single foam can have the same or different cross-sectional shapes. Longitudinal foam members can be solid foam or can be hollow, such as hollow foam tubes (see, for example, U.S. Pat. No. 4,755,408; incorporated herein by reference). The foam of one preferred embodiment of the present invention comprises multiple coalesced foam strands, especially wherein each said foam strand contain at least 50% PP, by weight of polymer in the foam strand.

Preparing coalesced polymeric foams typically involves extruding a foamable composition containing polymer resin and a blowing agent formulation through a die defining multiple holes, such as orifices or slits. The foamable composition flows through the holes, forming multiple streams of foamable composition. Each stream expands into a foam member. “Skins” form around each foam member. A skin can be a film of polymer resin or polymer foam having a density higher than an average density of a foam member it is around. Skins extend the full length of each foam member, thereby retaining distinguishability of each foam member within a coalesced polymeric foam. Foam streams contact one another and their skins join together during expansion, thereby forming a coalesced polymeric foam.

Other methods are available for joining longitudinal foam members together to form a foam including use of an adhesive between foam members and coalescing foam members together after they are formed by orienting the members and then applying sufficient heat, pressure, or both to coalesce them together. Similar processes are suitable for forming bead foam, which comprises multiple foam beads partially coalesced together. Bead foam is also suitable for use in the present invention.

Foams for use in the present invention can be either open-celled or close-celled. Close-celled foams have less than 20% open-celled content according to to ASTM method D-6226. Open-cell foams have 20% or more, preferably 50% or more, more preferably 70% or more open-cell content according to ASTM method D-6226. Open-celled foams are preferable over close-celled foams because they tend to be more flexible than close-celled foams.

Foams for use in the present invention can contain additives. Suitable additives include inorganic fillers, pigments, anti-oxidants, acid scavengers, ultraviolet radiation absorbers, flame retardants, surfactants, processing aids, extrusion aids, nucleating agents, static dissipating materials, cell enlarging agents, blowing agent permeation modifiers, and thermally insulating additives including aluminum, gold, silver, titanium dioxide, carbon black and graphite. Typically, add additives to a foamable composition prior to exposing the foamable composition to a foaming pressure. A skilled artisan can readily identify suitable combinations and concentrations of additives to achieve desirable properties within a foam.

Foams of the present invention have at least one slit traversing and severing a primary surface and penetrating a major distance into the foam without severing the opposing primary surface. For tubular and rod-shaped foams, a slit traverses a primary surface radially or, preferably, longitudinally. Except for rod-shaped forms, a slit severs a surface if it cuts the surface into at least two discontinuous pieces. Rod-shaped foams are unique in that they have only one primary surface. A slit severs a primary surface on a foam rod if it either extends longitudinally along the foam or partially around a foam rod's circumference while penetrating through the primary surface. A “major distance” is a distance sufficient to allow the foam to bend along a slit without fracturing or tearing any foam between the slit and the primary surface opposite to the slit. For board, plank, sheet and tubular foams, a major distance is desirably at least 70% of the foam's thickness. For rod-shaped foams, a major distance is desirably at least 70% of a distance from one point on the severed major surface along the slit to a point opposite to the slit. “Opposite” to a slit refers to that part of an opposing primary surface through which a slit would penetrate if it extended through that surface.

A slit may have a variable depth as it traverses a primary surface. For instance, a slit may alternately penetrate and not penetrate through an opposing surface opposite to the slit, thereby creating a perforated path as it traverses the opposing surface. At least a portion of an opposing primary surface opposite to the slit remains intact. Desirably, a slit penetrates through only one primary surface of a foam. A foam can contain more than one slit traversing a single primary surface. Additionally, a foam can have at least two slits that sever opposing primary surfaces, provided that at least a portion of each primary surface is in tact opposite to each slit.

A slit can follow any conceivable path as it traverses a primary surface including linear, curved, jagged, sinusoidal, or other complex patterns. Similarly, the slit can penetrate into a foam through a primary surface with any conceivable profile including a straight vertical (perpendicular to the primary surface) cut, a straight angled (other than perpendicular to the primary surface) cut, and “V”-, “U”-, or “W”-shaped cuts. “V”-, “U”-, and “W”-shaped cuts allow a foam to bend towards either a first or second primary face of the foam. For example, a planar board with a “V”-shaped slit can bend along the slit out of plane towards either the primary surface of the foam containing the slit or the primary surface of the foam opposing that containing the slit.

A skilled artisan can identify many different ways to introduce a slit into a foam. Introduction of a slit can occur during manufacture of the foam. For example, positioning a stationary razor (or spinning blade) such that after a foamable composition expands into a foam and while it is traveling in an extruded direction the razor (or spinning blade) slices a slit in the foam along the extruded direction. Alternatively, shuttle a razor across an extruding foam's surface thereby introducing a slit across the foam's width dimension. Introduction of a slit into a foam at any point after manufacturing a foam is also acceptable. For example, forming a slit with a razor, spinning blade, by milling, or by routing are all suitable. Milling and routing are particularly desirable for forming complex slit patterns and for forming complex slit profiles. Molding or blowing foams in such a way as to incorporate a slit without requiring subsequent cutting or milling is also acceptable.

Bending a foam along a slit compresses the primary foam surface opposing the primary surface through which the slit penetrates and can cause the foam to fracture. Such fracturing is undesirable, particularly when it causes the foam to break into more than one piece. Applying tape, film, foam sheet, or any combination thereof to the surface opposing the surface through with the slit penetrates can reinforce the foam, but requires manufacturing another material (the tape, film, or foam sheet) and application of the material to the foam. Foams of the present invention include reinforcement without requiring another material; they are inherently reinforced. The inherent reinforcement of the present invention strengthens the foam from fracturing when bending along a slit as well as when applying tensile stress without bending.

The present invention incorporates inherent reinforcement of a foam containing a slit on a primary surface by including a densified portion of an opposing primary surface proximate to the slit, including at least a portion of the opposing surface opposite to the slit. Desirably, though not necessarily, densify each point on a surface opposite a slit. A “densified” portion of foam surface is a section of a foam surface that has a density higher than an average density for the surface. Determine if a portion of a foam surface is “densified” by comparing a density for that portion of foam to an average surface density. Determine an average surface density for a foam surface by slicing (skiving) that surface off from the foam, determining the volume and weight of that skived surface, and dividing its weight by its volume. When skiving off a foam's surface, cut a portion of foam that extends at least 3 millimeters (mm), but not more than 5 mm into the foam. Determine the density of a portion of foam surface in a similar manner using only that portion of the foam surface in question.

Herein, a “portion” of foam surface does not include an entire foam surface. It is desirable to have a foam that has less than an entire foam surface densified. In contrast to foams of the present invention, PCT publication WO 01/56773A1 describes a foam plank that has a densified skin on an entire surface of a foam. Such a densified skin can act to close surface cell structure and to smooth the foam's surface, both of which can be detrimental, for example, in acoustical insulating applications. Such a skin also serves to increase the density of the entire foam, which can be detrimental in applications where minimal foam density is important, such as cushioning packaging applications. Foams of the present invention have at least a portion of each primary surface that remains non-densified, allowing for reinforcement of the foam's slit while minimizing detrimental affects of a densified skin surface. For example, non-densified portions of a foam surface tend to remain rougher and of lower density than densified portion of a foam surface. Additionally, foams of the present invention that have an open cell structure on their surface prior to densification still have an open cell structure on at least a portion of the surface (non-densified portion) after densification.

“Proximate” to the slit includes that portion of the opposing surface opposite the slit and extending a desired width along the opposing surface on either side of the slit. A densified portion of foam surface can extend a sufficient width to reinforce one slit or more than one slit, but does not cover an entire foam surface. Desirably, a densified portion of foam surface reinforces only one slit and includes all of the opposing surface opposite to a slit. In general for a given foam, densifying a portion of foam surface so that the width on either side of a slit is at least equal to half the foam's thickness is sufficient. Typically, a densified portion of foam surface is less than 10 centimeters (cm) wide. A skilled artisan can determine a sufficient width for a densified portion of foam surface for reinforcing a specific slit in a specific type of foam without undue experimentation.

Densified portions of a polymeric foam surface typically comprise a heat-densified foam. Heat-densify a portion of a polymeric foam surface by heating that surface to soften the polymer sufficiently to at least partially collapse the polymeric foam structure. Typically, heating a surface of a polymer foam to within 30° C., preferably within 10° C., more preferably to at least the polymer's glass transition temperature or melt temperature (for crystalline polymers) is sufficient. Desirably, apply pressure to a heated portion of foam surface to assist densifying that portion of foam surface. Apply pressure simultaneously with heat or after applying heat and before the polymer cools sufficiently to resist densification. Preferably, take care not to collapse an entire polymeric foam, or even a portion of a polymeric foam to less than 50% of its non-densified thickness. Generally, densify a foam to a depth (in a foam's thickness dimension) of less than 5 mm, preferably 3 mm or less, and generally 0.5 mm or more of a polymeric foam.

Artisans can identify methods of densification other than heat-densifying, such as densifying by introducing a solvent or plasticizer to a portion of a polymeric foam surface, all of which are part of the present invention.

Continuous and batch processes are both suitable for creating densified portions of a foam surface. Batch processes can occur at any time after forming a foam and are suitable for modifying individual foam structures. Continuous processes are desirable and can be part of a continuous polymeric foam production line. For example, a polymeric foam extrusion line can include a heating element, such as a hot plate, of some specific width over which an extruded foam travels. Heating the heating element to a temperature sufficient to at least partially melt the polymer of the foam, or to maintain such a temperature as the rest of the foam cools, and contacting the extruded foam with the heating element during extrusion can produce a densified portion of foam surface where the heating element contacts the foam. Hot air is also suitable instead of or in combination with a heating element to heat-densify a foam surface. Solvent-densify a portion of a foam surface in a manner similar to heat-densifying except apply a solvent or plasticizer to a portion of foam instead of heat. Apply solvent or plasticizer by spraying or wiping onto a foam. Densify a portion of a foam surface prior to, during, or after introducing a slit into the foam.

When heat-densifying, adjust the temperature of the heating element, the rate at which the foam travels over the heating element, the size of the heating element, or any combination thereof to control how much of the foam will soften, and therefore, the density of the densified portion of foam surface. Densify a foam surface sufficiently to reinforce it from breaking when bending a foam along a slit under conditions of intended use. Since intended uses may vary, specific densities can vary. Densifying to a higher density than needed is acceptable, but may hinder bending the foam and require unnecessary energy.

An artisan may want to densify other portions of a foam of the present invention. For example, using a hot wire or heated blade to cut the slit can simultaneously melt the foam within the slit, thereby densifying foam surfaces within the slit. Melting foam within a slit can further reinforce the foam.

Foams of the present invention have many uses including uses as packaging materials that can bend to conform to a box shape and as components in swimming pool covers. Foams of the present invention are particularly well suited for insertion into cavities, such as inter-rafter cavities, where a tight fit is desirable. Bending foams of the present invention facilitates installation into cavities that are smaller than the foam when uncompressed. For example, consider a cavity defined by two opposing walls (e.g., a ceiling cavity between joists) and a foam that is slightly wider than the cavity and that has a slit that extends lengthwise along the foam. Bending the foam along the slit allows two opposing edges of the foam to fit within the cavity. Placing the edges of the foam against the cavity walls and applying pressure against the slit surface extending out of the cavity compresses the foam against the cavity walls until the foam is entirely within the cavity. Desirably, the foam has to compress less than 25% in any given dimension in order to fit within a cavity.

Tubular foams of the present invention have particular utility as insulation around pipes, such as water pipes. For example, a tubular foam can have a cut that severs both inside and outside primary surfaces of the foam at one point on the foam's circumference and a slit extending longitudinally that severs only the inside surface of the foam and that penetrates a major distance into the foam with a densified portion of the outside surface of the foam proximate to the slit on another point on the foam's circumference. Such a tubular foam can bend open in a “C” configuration to facilitate placement around a pipe.

A foam of the present invention can, for example, enhance thermal insulation and acoustical attenuation through a space that it occupies or fill a cavity space for any other reason.

The following example further illustrates the present invention, without limiting the scope of the invention.

### EXAMPLE (EX) 1 AND COMPARATIVE EXAMPLE (COMP EX) A

Prepare Comp Ex A using an extruded polypropylene insulation foam having a density of one pound-per-cubic-foot (16 kilograms-per-cubic-meter), available from The Dow Chemical Company. The foam comprises multiple coalesced extruded foam strands extending in the extrusion (length) dimension of the foam. Use a sample of foam that is 2500 mm long, 600 mm wide, and 50 mm thick.

Cut a slit along the length of the foam and down the center of the foam's width using a table saw. Length and width of the foam define the primary surfaces. The slit penetrates through a first primary surface of the foam, but not an opposing second primary surface. The slit has a width of 3 mm and a depth of 40 mm.

Prepare Ex 1 similarly to Comp Ex A except heat-reinforce Ex 1 using a hot plate in a TARA machine. The hot plate has a width of 50 mm, a length of 20 mm, and extends above the TARA machine's table less then one mm. Heat the hot plate to 200 degrees Celsius (° C.). Translate the foam over the hot plate with the second primary surface against the hot plate and with the slit centered over the hot plate. Translate the foam over the hot plate at a rate of 1 meter per minute, translating in the length direction of the hot plate. A 50 mm wide section of the second face melts and densifies during exposure to the hot plate, producing an inherently reinforced foam.

Reinforcement effects of the densified portion of the second surface are apparent by comparing Manual Bend Test results and tensile properties testing results of Ex 1 to Comp Ex A.

Manual Bend Test

Conduct a bend test on Ex 1 and Comp Ex A by bending along the slit in each foam 120° from planar. Bend the foams in a manner that opens the slit, hinging on the 10 mm portion of foam between the slit and the second face of the foam.

Comp Ex A breaks immediately after bending one time. In contrast, Ex 1 remains unbroken after bending 50 times.

Tensile Properties Testing

Cut five test samples from each of Ex 1 and Comp Ex A. Each test sample is 50 mm in the extrusion direction (length) and 50 mm wide. The slit extends along the length and is in the center of the 50 mm sample width. Cut each test sample to a 5 mm thickness that includes the second face and extends up towards the slit 5 mm. Each test sample captures a section of foam that contains half of the 10 cm portion of foam between the slit and the second face of the foam.

Measure tensile properties on an Instron instrument by pulling on a test sample in its width direction at a 20 millimeter-per-minute rate. Test results are in Table 1.

TABLE 1

| Parameter | Units | Comp Ex A | Ex 1 |
|---|---|---|---|
| Stress at Peak | kiloPascals | 94 | 116 |
| Strain at Peak | percent | 34 | 29 |
| Young's | kiloPascals | 365 | 900 |
| Modulus | | | |
| Toughness | kiloPascals | 19 | 22 |

Ex 1 illustrates an inherently reinforced thermoplastic polymer foam containing a slit through one surface and a heat-densified surface portion of on an opposing surface and in the vicinity of the slit. The heat-densified surface portion reinforces the foam. The inherent reinforcement is evident by comparing Manual Bending Test results and Tensile Property Test results of Ex 1 with a similar foam whose second surface does not contain a densified portion for reinforcement (Comp Ex A). Ex 1 can bend many more times than Comp Ex a without breaking in the Manual Bending Test and has higher stress at peak, yet lower strain at peak, as well as a higher Young's Modulus and toughness values in the Tensile Properties testing than Comp Ex A.

What is claimed is:

1. A polymeric foam comprising a deformable polymer having multiple cells defined therein, wherein said foam has:
(a) opposing primary surfaces;
(b) at least one slit traversing and severing a primary surface while penetrating a major distance into the foam without severing the opposing primary surface;
(c) a densified portion of the opposing primary surface that is proximate to said slit, including at least a portion of the opposing surface opposite to said slit.

2. The foam of claim 1, wherein said foam is an open-celled foam.

3. The foam of claim 1, wherein said deformable polymer comprises at least 50 percent polypropylene, based on deformable polymer weight.

4. The foam of claim 1, wherein said polymer foam comprises multiple coalesced foam strands.

5. The foam of claim 4, wherein said foam is open-celled and said deformable polymer comprises at least 50 percent polypropylene based on deformable polymer weight.

6. The foam of claim 1, wherein said foam is a board, plank or sheet.

7. The polymeric foam of claim 1, comprising at least two slits that sever opposing primary surfaces, provided that at least a portion of each primary surface opposite to each slit is intact.

8. The foam of claim 1, wherein said polymeric foam is a tubular foam structure and said first and second primary surfaces are selected from an inside surface and an outside surface.

9. A process for modifying a polymeric foam comprising, in any order, the following steps:
(a) introducing a slit that traverses and severs a primary surface of a foam while penetrating into said foam without severing an opposing primary surface; and
(b) densifying a portion of said opposing primary surface such that, after introducing the slit, the densified portion of opposing surface is proximate to the slit.

10. The process of claim 9, wherein said polymeric foam is open-celled.

11. The process of claim 9, wherein step (b) involves softening a portion of said opposing primary surface by applying heat.

12. The process of claim 9, wherein step (b) includes translating the foam over a heating element that contacts the foam in the area or areas being heat-densified.

13. The process of claim 9, wherein said foam is a coalesced foam.

14. The process of claim 9, wherein said foam comprises a deformable polymer having cells defined therein, wherein said deformable polymer consists of at least 50 percent polypropylene, by weight of deformable polymer.
